(19) United States
(12) Patent Application Publication
(10) Pub. No.: US 2014/0144473 A1
(43) Pub. Date: May 29, 2014

(54) Method For In-Situ Cleaning Of Compressor Blades In A Gas Turbine Engine On An Aircraft And Compositions

(71) Applicant: David William MARTIN, Liverpool (GB)

(72) Inventor: David William MARTIN, Liverpool (GB)

(73) Assignee: FORMATEX (OFFSHORE) S.A.L., Jal El Dib (LB)

(21) Appl. No.: 14/167,547

(22) Filed: Jan. 29, 2014

(30) Foreign Application Priority Data
Jul. 29, 2011 (GB) 1113083.8
Jul. 27, 2012 (GB) PCT/GB2012/051822

(51) Int. Cl. F01D 25/00; C11D 3/20

(52) U.S. Cl. CPC F01D 25/002; C11D 3/2041
USPC 134/26; 510/187

(57) ABSTRACT

A method for in-situ cleaning of compressor blades in a gas turbine engine on an aircraft comprises the following sequential steps:
Step 1—washing said compressor blades by spraying a first liquid composition into the engine; and
Step 2—finally rinsing said washed compressor blades by spraying a second liquid composition into the engine,
   wherein the second liquid composition, has a freezing point of −10° C. or below and is non-aqueous and hydrophilic.

### FIELD OF THE INVENTION

This invention is related to a method for in-situ cleaning of compressor blades in a gas turbine engine on an aircraft and to compositions suitable for use in such a method.

The invention enables the removal of contaminant dirt from the blades of a gas turbine engine. This removal of contaminant dirt from the blades restores the aerodynamic airflow within the engine, so reducing drag and improving fuel efficiency.

### BACKGROUND OF THE INVENTION

A typical jet engine compressor consists of hundreds of individual blades arranged in multiple rows, with each row called a compressor stage. The blades are designed as aerofoils to reduce aerodynamic drag. Aerofoils require smooth airflow patterns to work. Any protrusion on the aerofoil or sudden change in shape can result in turbulent airflow, aerodynamic drag and loss of aerodynamic performance. Jet engine compressor blades can accumulate a small but significant layer of dirt, which has a measurable effect on engine performance and therefore fuel consumption. The loss of performance can vary between 0.5 and 3% depending on the engine type and operating conditions.

In-situ methods for cleaning gas turbine engines are well known, such as those described in Scheper et al, “Maintaining Gas Turbine Compressors for High Efficiency”, Power Engineering, August 1978, pages 54-57, and in Braaten, “In-service Cleaning of Power Units”, The Indian and Eastern Engineer, Vol, 124, March 1982, and apparatus for effecting such methods are also well known, such as those described in U.S. Pat. No. 4,059,124 (Bartos et al) and US2006/0219269 (Rice et al).

Jet engine compressors are built almost entirely of metals or composites, so a chemical cleaning agent should offer a simple effective solution. However, the engine is used as a source of compressor air for a number of pneumatic systems within and external to the engine. Additionally, cold operating temperatures can lead to the formation of ice on compressor blades or in engine pneumatic systems. Finally, as aviation is criticised for its environmental impact, airports are closely monitored for noise and to ensure that pollutants are not released into the local water table.

Engine compressor cleaning procedures have been developed to remove dirt deposits on the compressor blades, and on other parts within the engine, to minimise the risk of engine icing and to minimise the risk of contaminating the compressor cabin bleed air. However, little attention has been paid to the environmental impact of cleaning procedures, beyond through the use of biodegradable cleaning fluids.

Engine manufacturers have two principle concerns regarding engine cleaning (1) engine icing and (2) contamination of the engine oil system. Engine compressor air is tapped off the compressor to provide information to the engine control system, which is usually mounted on the engine casing. Despite the proximity to the engine, the engine control system is subjected to ambient temperatures and pressures, and any water in low flow-rate pressure lines is at risk of icing, and consequential failure of the engine control system. Engine manufacturers therefore require disconnection and purging of these lines after engine compressor washing. The risk of compressor blade icing is minimised by running the engine after compressor cleaning. The engine oil systems typically rely on compressor air buffered seals to reduce the oil consumption rate. Any liquid entering the compressor air bleed system, or entering the oil seals while the engine is not running, can contaminate the engine oil system. A simple solution to the problem of engine oil contamination is to carry-out the compressor wash with the engine running, however, the fan at the front of modern engines acts as a centrifuge, making it extremely difficult to direct the washing liquids into the compressor inlet behind the fan. The current non-aqueous compositions described herein are able to mix with the engine oil with no adverse effects.

WO01/40548 (Biogenis Enterprises, Inc) discloses a water-based, biodegradable solution for cleaning a gas turbine engine. A typical cleaning procedure is disclosed which involves “crank washing” with the cleaning solution followed by rinsing with DI water. The used cleaning solution and rinse water escapes from the turbine engine through drain ports, but the residuals can pool in the engine and/or remain leaving the cleaned engine components damp. The liquid residuals may be blown out when the engine is eventually running. This “crank washing” procedure is typically used when ambient temperatures at ground level are above 5° C. Another procedure involves “on-line cleaning” with a cleaning solution, where the contaminants and used cleaning solution pass through the combustor section which operates at up to 3200° F.

US2005/0049168 discloses a composition and process for cleaning a gas turbine engine using a liquid composition comprising a mixture of (a) a glycol alkyl ether compound, (b) an alkoxylated surfactant with an alkyl chain length of from about 3 to 18 carbons and (c) a metal corrosion inhibitor compound. However, this document does not disclose rinsing with a non-aqueous composition.

EP-A-0275987 discloses a concentrate composition which is diluted with water to provide an aqueous composition that is useful in a method for cleaning gas turbine compressors.

U.S. Pat. No. 5,279,760 discloses a composition that is used in an aqueous form for cleaning gas turbine air compressors. The composition comprises a solvent component consisting of a combination of a particular monovalent aliphatic alcohol-ethylene glycol adduct and a particular phenol-ethylene glycol adduct, and a surfactant component consisting of a combination of a particular polyethylene glycol mono(alkylphenol) ether and an ammonium or amine salt of a particular fatty acid.

When ambient temperatures at ground level are 5° C. or less, and so a possibility of freezing conditions exist, current standard procedures requires the above “crank washing” procedure to be modified, wherein rather than simply cranking the engine with a starter motor, the engine is actually started and run at idle during and/or at the end of the procedure so as to blow out the residual washing fluid and rinse water and dry the engine components, before the residual washing fluid or rinse water can freeze on damp components and/or pool and freeze in the engine. To address the concern of oil system contamination, the engine is then run at high power, to heat the oil system and boil off any water in the oil. Typically airlines insist that when an aircraft turbine engine is cleaned at temperatures below 5° C. the use of an anti-icing agent must be included in the aqueous cleaning fluids. Typically these anti-icing materials include chemicals such as isopropyl alcohol. However, due to concerns regarding cabin air contamination, and the requirement to ensure that these chemicals are captured and disposed of appropriately, several airlines are reluctant or unable to carry-out engine washing at low ambient temperatures.

As well as the undesirable fuel usage incurred by running the engines during the above cleaning procedures, particularly at temperatures below 5° C., when it is necessary to run the engines the procedures must be worked around any curfews imposed by some airports on engine noise.

Further, whilst most of the residuals from the cleaning process may be blown out or dried when the engine is run, some residuals may not be removed. Residuals that remain in the engine once the aircraft is airborne can freeze at the low temperatures experienced at high altitudes. The frozen residuals can affect detrimentally the engine performance and/or engine managements systems, especially if permitted to build-up over a period of time.

It is an object of the present invention to provide a cleaning procedure which can be operated at temperatures below 5° C. without essentially having to start the engines and which preferably will reduce or eliminate the potential of formation of frozen residuals in the engine.

### SUMMARY OF THE INVENTION

The present invention, in its various aspects, is set out in the accompanying claims.

In a first aspect, the present invention provides a method for in-situ cleaning of compressor blades in a gas turbine engine on an aircraft, said method comprising the following sequential steps:
Step 1—washing said compressor blades by spraying a first liquid composition into the engine; and
Step 2—as a final step in which any liquid composition is sprayed into the engine, rinsing said washed compressor blades by spraying a second liquid composition into the engine;
   characterised in that said second liquid composition has a freezing point of −10° C. or below and is substantially non-aqueous and hydrophilic; and
   said first liquid composition is the same as or different from said second liquid composition.

In another aspect of the present invention, there is provided a method for in-situ cleaning of compressor blades in a plurality of gas turbine engines on one or more aircraft, said method comprising the following sequential steps:
Step 1—washing the compressor blades in a first gas turbine engine on an aircraft by spraying a first liquid composition into said engine and draining at least a portion of the used first liquid composition into a collecting tank;
Step 2—as a final step in which any liquid composition is sprayed into said first turbine engine, rinsing said washed compressor blades in said first gas turbine engine by spraying a second liquid composition into said first engine, draining at least a portion of the used second liquid composition into said collecting tank and mixing said used second liquid composition with said first liquid composition in said collecting tank;
Step 3—washing the compressor blades in a second gas turbine engine by spraying a liquid composition derived form said collecting tank into said second engine and draining at least a portion of said used liquid composition derived from said collecting tank back into said collecting tank; and
Step 4—as a final step in which any liquid composition is sprayed into said second gas turbine engine, rinsing said washed compressor blades in said second gas turbine engine by spraying said second liquid composition into the engine, draining at least a portion of the used second liquid composition into said collecting tank and mixing said used second liquid composition with any liquid composition in said collecting tank; and
optionally repeating Step 3 and Step 4 as required to clean the compressor blades of subsequent gas turbine engine;
   wherein said second liquid composition has a freezing point of −10° C. or below and is non-aqueous and hydrophilic; and wherein said first liquid composition is the same as or different from said second liquid composition.

The second liquid composition preferably comprises one or more organic solvents having a freezing point of −10° C. or below. Preferably, the solvent is a glycol, preferably a glycol chosen from methylene glycol, dimethylene glycol, trimethylene glycol, ethylene glycol, propylene glycol, dipropylene glycol and butyl glycol. Most preferably the solvent is methylene glycol.

The second liquid composition preferably comprises one or more non-ionic surfactants, preferably one or more surfactants chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

Preferably, the second liquid composition comprises one or more organic solvents chosen from methylene glycol, dimethylene glycol, trimethylene glycol, ethylene glycol, propylene glycol, dipropylene glycol and butyl glycol, preferably methylene glycol; and one or more surfactants chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

Preferably, when the second liquid composition comprises at least one organic solvent and at least one non-ionic surfactant, the amounts of the solvent(s) and surfactant(s) in the second liquid composition are such that the second liquid composition has a freezing point of −20° C. or less, more preferably −30° C. or less, even more preferably −40° C. or less, and most preferably −50° C. or less.

When the second liquid composition comprises at least one organic solvent and at least one non-ionic surfactant, the amount of solvent in the composition preferably ranges from 1-99 wt %, preferably 40-95 wt % and more preferably 75-95 wt %.

When the second liquid composition comprises at least one organic solvent and at least one non-ionic surfactant, the amount of non-ionic surfactant in the composition preferably ranges from 1-99 wt %, preferably 1-60 wt %, e.g. 5-60 wt %, and more preferably 1-25 wt %, e.g. 5-25 wt %.

The second liquid composition is non-aqueous. As a non-aqueous composition, no water is used as a component per se in the second liquid composition. Nevertheless, a skilled person will recognise that a negligible amount of water may be present in the second liquid composition by virtue of its presence in a very small amount, e.g. by absorption of moisture from the atmosphere, as a residue or by use, in a component that is used to form the second liquid composition or, because the second liquid composition is hydrophilic, by absorption of moisture from the atmosphere. The amounts of water that are present in commercially available components that are suitable for use in or as the second liquid composition are such that the second liquid composition typically comprises no more than 1 wt %, preferably no more than 0.5 wt %, more preferably 0.25 wt %, water. Most preferably, the second liquid composition contains no water.

The second liquid composition is hydrophilic. Being hydrophilic, water tends to be miscible in the second liquid composition at the temperature at which the method of the present invention is performed. Preferably water is miscible in the second liquid composition at a temperature at least 10° C., more preferably at least 20° C., even more preferably at least 30° C., below the temperature at which the method of the present invention is performed. Preferably, water is soluble in the second liquid composition at the temperature at which the method of the present invention is performed. Preferably water is soluble in the second liquid composition at a temperature at least 10° C., more preferably at least 20° C., even more preferably at least 30° C., below the temperature at which the method of the present invention is performed.

The second liquid composition is preferably hygroscopic at the temperature at which the method of the present invention is performed. Preferably, the second liquid composition is hygroscopic at a temperature at least 10° C., more preferably at least 20° C., even more preferably at least 30° C., below the temperature at which the method of the present invention is performed.

When a quantity of the second liquid composition comes into contact with a quantity of water, the water mixes with the second liquid composition to form a composition having a freezing point less than the freezing point of water.

The surfactants are preferably non-ionic in nature. Examples of surfactants useful in the present invention include alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted silicone, quaternary amines, alkyloxazolines, alkenyloxazolines, imidazolines, alkyl-sulphonates, alkylarylsulphonates, alkylsulfosuccinates, alkyl-phosphates, alkenylphosphates, phosphates esters, and/or derivatives thereof.

The second liquid composition may also include one or more other components, preferably in an amount of from 0.5 to 5 wt %. Such one or more other components may include low viscosity silicone oil, synthetic oils (such as esters) and refined kerosene, which may aid in freeze point depression, improve degreasing properties and/or reduce any foaming that the surfactant(s) might introduce. The other component(s) may be a substance such as a corrosion inhibitor, etc. These other components will be apparent to those skilled in the art.

The first liquid composition is the same as or different from the second liquid composition. The first liquid composition preferably comprises the second liquid composition. In one embodiment, the first liquid composition consists of the second liquid composition. Preferably, however, the first liquid composition is an aqueous composition preferably comprising 50-90 wt %, more preferably 60-80 wt %, water. Preferably the first liquid composition comprises the second liquid composition and water, preferably in a weight ratio of 1:1 to 5, more preferably 1:3 to 4.5, most preferably 1:4.

The first and/or second liquid compositions are preferably biodegradable. More preferably, both first and second liquid compositions are biodegradable. The term biodegradable represents a composition that is capable of being decomposed by bacteria or other living organisms and thereby avoiding pollution (Oxford Dictionary Online).

By use of the method of the present invention, it possible to clean turbine engines on an aircraft at ambient temperatures below 5° C. without having to run the engines. In some preferred embodiments of this invention, it is possible to clean turbine engines on aircraft at ambient temperatures below 0° C. without having to run the engines. Thus, there is a potential for saving of fuel, which would otherwise be burnt by running the engines, and, because the engines do not need to be running for cleaning, the method of the present invention enables the cleaning of engines to take place when there is a curfew against running of engines. As a further benefit of the present invention, the second liquid composition may reduce or eliminate the risk of any residual cleaning fluids in the engine from freezing, as may occur on the ground or in the initial ascent of the aircraft to cruising altitudes.

In another aspect, the present invention provides a non-aqueous composition intended for use as the second liquid composition, said composition comprising:
a) 75-95 wt % of one or more organic solvents chosen from methylene glycol, dimethylene glycol and trimethylene glycol, preferably trimethylene glycol; and
b) at least 5 wt % of one or more surfactants, wherein the surfactants are chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

In one embodiment of the invention, the second liquid composition provides for a fluid that will have minimum impact on the engine oil should the fluids come into contact during the wash process.

As a benefit of the present invention, as the second composition is non-aqueous considerable time and fuel are not wasted with the boiling off of contaminant water by running the engines.

In one embodiment of the invention, the second liquid composition is preferably formulated to allow for washing at below 5° C. without the need to include chemicals that will have an adverse effect on the compressor air system and as such on the air used in the aircraft cabin. This prevents the need for a purge of the aircraft compressor system.

### DETAILED DESCRIPTION OF THE INVENTION

The present invention provides compositions and method of use in the cleaning of aircraft engine compressor turbine blades.

Other than in the operating examples, or where otherwise indicated all numbers expressing quantities of ingredients used herein are to be understood as modified in all instances by the term “about”.

A person skilled in the art will appreciate that the methods of the present invention may be performed using conventional apparatus for on-line cleaning of gas turbine engines on aircraft, such as the apparatus disclosed in U.S. Pat. No. 4,059,123 and US2006/0219269, and employing the procedures generally described in Scheper and Braaten above. However, instead of using water or an aqueous composition, as has been conventionally used in the past, the engine is sprayed with a non-aqueous, hydrophilic composition that has a freezing point of −10° C. or below as a final rinse.

In a preferred embodiment the second liquid composition comprises at least 50% wt solvent and more preferably 75% wt. The second liquid composition is then comprised of one or more surfactants to make up the balance to 100% wt. The use of additional components is not excluded and will be apparent to those skilled in the art. The composition will be described as non-aqueous in that in its neat form no water is deliberately added and that any water present in the composition is present only as contaminant in the original products. Typically, this will give rise to a composition that is less than 1% w/w of water.

The solvent is preferably chosen from the glycol family and includes methylene glycol, dimethylene glycol, trimethylene glycol, ethylene glycol, propylene glycol, dipropylene glycol and butyl glycol. Preferably, the solvent is trimethylene glycol.

The surfactant can be chosen from, but is not limited to the list below:

alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted silicone, quaternary amines, alkyloxazolines, alkenyloxazolines, imidazolines, alkyl-sulphonates, alkylarylsulphonates, alkylsulfosuccinates, alkyl-phosphates, alkenylphosphates, phosphates esters, and/or derivatives thereof.

The second liquid composition may be diluted with water when it is used as to wash the engine blades. The dilution can be of the order 1 part composition to up to 5 parts water. This aqueous, diluted product may be used in the washing step(s). The amount of dilution will vary depending upon the cleaning power required and the temperature at which the cleaning procedure is to be used.

Once the blades of the engine are washed, a rinse consisting of the second liquid composition is applied to the blades, so as to absorb any residual water present and minimise any new contaminant deposition.

It will be appreciated that, when cleaning an aircraft engine, the washing step may comprise a single or a plurality of washing cycles and the rinse step may comprise a single or a plurality of rinse cycles. However, irrespective of how many wash or rinse cycles there may be in an engine cleaning process, the step of rinsing of the washed compressor blades by spraying a second liquid composition into the engine refers to the final spraying into the engine of a liquid composition during the cleaning process i.e. Step 2 as defined above is the final step in which any liquid composition is sprayed into the engine during the cleaning process.

The present invention will now be further described by way of example.

### EXAMPLES

In the following examples, all “parts” are parts by weight and all “percentages” are percentages by weight, unless stated otherwise.

### Example 1

A composition was prepared for cleaning engine turbine blades using the following ingredients

| | | |
|---|---|---|
| a) | Trimethylene Glycol | 65% |
| b) | Sorbitan Mono-Oleate | 3% |
| c) | Triethanolamine | 2% |
| d) | Silicone Oil | 30% |

The fluids were mixed gently to form a homogenous fluid.

### Example 2

A composition was prepared for cleaning engine turbine blades using the following ingredients

| | | |
|---|---|---|
| a) | Trimethylene Glycol | 85% |
| b) | Synthetic Ester | 10% |
| c) | Oleic Diethanolamide | 3% |
| d) | Triethanolamine | 2% |

The fluids were mixed gently to form a homogenous fluid.

### Example 3

A composition was prepared for cleaning engine turbine blades using the following ingredients

| | | |
|---|---|---|
| a) | Trimethylene Glycol | 90% |
| b) | Sorbitan Mono-Oleate | 9% |
| c) | Polysorbate 80 | 1% |

The fluids were mixed gently to form a homogenous fluid.

### Example 4

A composition was prepared for cleaning engine turbine blades using the following ingredients

| | | |
|---|---|---|
| a) | Trimethylene Glycol | 75% |
| b) | Silicone Oil | 20% |
| c) | Sorbitan Mono-Oleate | 3% |
| d) | EO/PO substituted Siloxane | 2% |

The fluids were mixed gently to form a homogenous fluid.

### Example 5

A composition was prepared for cleaning engine turbine blades using the following ingredients

| | | |
|---|---|---|
| a) | Trimethylene Glycol | 95% |
| b) | Oleic Diethanolamide | 3% |
| c) | OleylErucate | 2% |

The fluids were mixed gently to form a homogenous fluid.

### Example 6

A composition was prepared for cleaning engine turbine blades using the following ingredients

| | | |
|---|---|---|
| a) | Trimethylene Glycol | 75% |
| b) | Sorbitan Mono-Oleate | 22.5% |
| c) | Triethanolamine | 2.5% |

The fluids were mixed gently to form a homogenous fluid.

### Example 7

A composition was prepared for cleaning engine turbine blades using the following ingredients

| | | |
|---|---|---|
| a) | Trimethylene Glycol | 65% |
| b) | Sorbitan Mono-Oleate | 3% |
| c) | Triethanolamine | 2% |
| d) | EO/PO substituted Siloxane | 10% |
| e) | Silicone Oil | 30% |

The fluids were mixed gently to form a homogenous fluid.

### Example 8

A composition was prepared for cleaning engine turbine blades using the following ingredients

| | | |
|---|---|---|
| a) | Ethylene Glycol | 85% |
| b) | Silicone Oil | 10% |
| c) | Oleic Diethanolamide | 3% |
| d) | Triethanolamine | 2% |

The fluids were mixed gently to form a homogenous fluid.

### Example 9

A composition was prepared for cleaning engine turbine blades using the following ingredients

| | | |
|---|---|---|
| a) | Dimethylene Glycol | 80% |
| b) | Sorbitan Mono-Oleate | 9% |
| c) | Polysorbate 80 | 1% |
| d) | Odourless Kerosene | 10% |

The fluids were mixed gently to form a homogenous fluid.

### Example 10

A composition was prepared for cleaning engine turbine blades using the following ingredients

| | | |
|---|---|---|
| a) | Butyl Glycol | 75% |
| b) | Silicone Oil | 20% |
| c) | Sorbitan Mono-Oleate | 3% |
| d) | EO/PO substituted Siloxane | 2% |

The fluids were mixed gently to form a homogenous fluid.

### Example 11

The compositions from Examples 1 to 10 were evaluated for anti-icing properties and found to remain liquid at temperatures below −20° C.

### Example 12

The compositions from claims 1 to 10 were diluted at 25% wt composition to 75% wt water. These diluted mixtures were evaluated for anti-icing properties and were found to remain liquid to −10° C.

### Example 13

The fluids from example 12 were used to evaluate cleaning potential and all were found to give adequate cleaning in the diluted state. This was done in accordance with the guidelines outlined in UK Ministry Of Defence, Defence Standard 79-18, Issue 2, 23 May 2001.

### Example 14

The fluids from the previous examples have been evaluated for biodegradability using information/literature that is readily available. It is anticipated that all fluids are readily biodegradable.

### Example 15

In one embodiment of the method of the present invention, the compressor blades of a gas turbine engine on an aircraft may be cleaned using a mobile on-wing engine washing and reclamation system substantially as described in US2006/0219269 (the disclosures of which are incorporated herein by reference), but wherein the system is modified to have interchangeable first and second cleaning liquid sources containing first and second liquid compositions, respectively, and wherein the system is further modified such that any reclaimed liquid composition is only pumped to the first cleaning liquid source, whereas the second cleaning liquid source does not receive any reclaimed liquid composition.

At the start of the engine cleaning process, the first cleaning liquid source contains a first liquid composition that is an aqueous fluid comprising about 20 wt % of the composition from Example 1 and about 80 wt % water. During the cleaning process, the engine is initially washed with from about 100 to about 200 litres of the first liquid composition using a spray applicator connected to the first cleaning liquid source, and any used first liquid composition that is captured is reclaimed and pumped back to the first cleaning liquid source.

After washing is complete, the engine is then rinsed with a second liquid composition, consisting of the non-aqueous, hydrophilic composition from Example 1, using a spray applicator connected to the second cleaning fluid source. Only a relatively small amount, e.g. less than 50 litres, such as 25 litres or less, of second liquid composition is required to rinse the engine. Any used second liquid composition that is captured and reclaimed is then pumped to the first cleaning liquid source where it is allowed to mix with the first liquid composition.

The mobile on-wing engine washing and reclamation system may then be moved so that the above process may be repeated to clean one or more other engines, but using the reclaimed mixture of first and second liquid compositions in the first cleaning liquid source.

Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. A method for in-situ cleaning of compressor blades in a gas turbine engine on an aircraft, said method comprising the following sequential steps:
Step 1—washing said compressor blades by spraying a first liquid composition into the engine; and
Step 2—as a final step in which any liquid composition is sprayed into the engine, rinsing said washed compressor blades by spraying a second liquid composition into the engine;
characterised in that said second liquid composition has a freezing point of −10° C. or below and is non-aqueous and hydrophilic; and
said first liquid composition is the same as or different from said second liquid composition.

2. A method for in-situ cleaning of compressor blades in a plurality of gas turbine engines on one or more aircraft, said method comprising the following sequential steps:
Step 1—washing the compressor blades in a first gas turbine engine on an aircraft by spraying a first liquid composition into said engine and draining at least a portion of the used first liquid composition into a collecting tank;
Step 2—as a final step in which any liquid composition is sprayed into said first gas turbine engine, rinsing said washed compressor blades in said first gas turbine engine by spraying a second liquid composition into said first engine, draining at least a portion of the used second liquid composition into said collecting tank and mixing said used second liquid composition with said first liquid composition in said collecting tank;
Step 3—washing the compressor blades in a second gas turbine engine by spraying a liquid composition derived form said collecting tank into said second engine and draining at least a portion of said used liquid composition derived from said collecting tank back into said collecting tank; and
Step 4—as a final step in which any liquid composition is sprayed into said second gas turbine engine, rinsing said washed compressor blades in said second gas turbine engine by spraying said second liquid composition into the engine, draining at least a portion of the used second liquid composition into said collecting tank and mixing said used second liquid composition with any liquid composition in said collecting tank; and
optionally repeating Step 3 and Step 4 as required to clean the compressor blades of subsequent gas turbine engine(s);
wherein said second liquid composition has a freezing point of −10° C. or below and is non-aqueous and hydrophilic; and
wherein said first liquid composition is the same as or different from said second liquid composition.

3. The method according to claim 1, wherein said first liquid composition is aqueous.

4. The method according to claim 1, wherein said first liquid composition comprises the second liquid composition and water in a weight ratio of 1:1-5, more preferably 1:3-4.5, most preferably 1:4.

5. The method according to claim 2, wherein the liquid composition derived form said collecting tank comprises the second liquid composition and water in a weight ratio of 1:1-5, more preferably 1:3-4.5, most preferably 1:4.

6. The method according to claim 1, wherein said second liquid composition comprises:
a) one or more organic solvents chosen from methylene glycol, dimethylene glycol, trimethylene glycol, ethylene glycol, propylene glycol, dipropylene glycol and butyl glycol; and/or
b) one or more surfactants chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

7. The method according to claim 6, wherein said organic solvent is trimethylene glycol.

8. The method according to claim 6, wherein said surfactant is one or more of polyisobutylenesuccinimide, oleic diethanolamide, EO/PO substituted siloxane and sorbitan ester, preferably sorbitan mono-oleate.

9. The method according to claim 6, wherein said second liquid composition also comprises one or more of silicone oil, preferably of viscosity<50 cSt, synthetic oil, odourless kerosene and corrosion inhibitors, preferably triethanolamine.

10. The method according to claim 1, wherein the second liquid composition contains trimethylene glycol, Sorbitan mono-oleate, triethanolamine, silicone oil, synthetic oil and odourless kerosene.

11. The method according to claim 2, wherein the gas turbine engines are on a plurality of aircraft.

12. A non-aqueous composition intended for use as the second liquid composition used in Step 2 of the method claimed in claim 1, said composition comprising:
a) 75-95 wt % of one or more organic solvents chosen from methylene glycol, dimethylene glycol and trimethylene glycol; and
b) at least 5 wt % of one or more surfactants, wherein the surfactants are chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

13. Use of a non-aqueous composition as claimed in claim 12, in a method for in-situ cleaning of compressor blades in a gas turbine engine on an aircraft, wherein said use is for preventing ice formation in the engine by absorbing residual water and maintaining it in the liquid state to temperatures below −10° C.

14. The method according to claim 2, wherein said first liquid composition is aqueous.

15. The method according to claim 2, wherein said first liquid composition comprises the second liquid composition and water in a weight ratio of 1:1-5, more preferably 1:3-4.5, most preferably 1:4.

16. The method according to claim 2, wherein said second liquid composition comprises:
a) one or more organic solvents chosen from methylene glycol, dimethylene glycol, trimethylene glycol, ethylene glycol, propylene glycol, dipropylene glycol and butyl glycol; and/or
b) one or more surfactants chosen from alcohol ethoxylates, phenol alkoxylates, poly(oxyalkylene) glycols, poly(oxyalkylene) fatty acid esters, amine alkoxylates, poly(alkyl) succinimides, poly(alkenyl) succinimides, fatty acid esters of sorbitol and glycerol, fatty acid salts, sorbitan esters, poly(oxyalkylene) sorbitan esters, fatty amine alkoxylates, poly(oxyalkylene) glycol esters, fatty acid amides, fatty acid amide alkoxylates, fatty amines, EO/PO substituted siloxane, quaternary amines, alkyloxazolines, alkenyloxazolines, imidazolines, alkyl-sulphonates, alkylarylsulphonates, alkylsulfosuccinates, alkyl-phosphates, alkenylphosphates, and phosphates esters.

17. The method according to claim 7, wherein said surfactant is one or more of polyisobutylenesuccinimide, oleic diethanolamide, EO/PO substituted siloxane and sorbitan ester, preferably sorbitan mono-oleate.

18. The method according to claim 2, wherein the second liquid composition contains trimethylene glycol, Sorbitan mono-oleate, triethanolamine, silicone oil, synthetic oil and odourless kerosene.
